(19) United States
(12) Patent Application Publication
(10) Pub. No.: US 2019/0392704 A1
(43) Pub. Date: Dec. 26, 2019

(54) VEHICLE ACCESSORY DEVICE OPERATING SYSTEM

(71) Applicant: Eberspächer Climate Control Systems GmbH & Co. KG, Esslingen (DE)

(72) Inventor: Felix Waniek, Aichwald (DE)

(21) Appl. No.: 16/445,853

(22) Filed: Jun. 19, 2019

(30) Foreign Application Priority Data
Jun. 21, 2018 (DE) 10 2018 114 906.9

(51) Int. Cl. G08C 17/00; H04W 4/40; B60R 16/023

(52) U.S. Cl. CPC G08C 17/00; B60P 3/32; B60R 16/023; H04W 4/40

(57) ABSTRACT

A vehicle accessory device operating system includes a plurality of accessory devices (28, 30, 32) housed or to be housed in a vehicle, a communication unit (36), an accessory device data transmission system (38) and at least one mobile operating unit (40). The accessory device data transmission system (38) connects the plurality of accessory devices (28, 30, 32) for the exchange of data with the communication unit (36). The communication unit (36) is configured for the exchange of data with the at least one mobile operating unit (40) via a first wireless data transmission system (42). The communication unit (36) is configured for the exchange of data with a remote access system (46) via a second wireless data transmission system (44).

### CROSS REFERENCE TO RELATED APPLICATIONS

This application claims the benefit of priority under 35 U.S.C. § 119 of German Application 10 2018 114 906.9, filed Jun. 21, 2018, the entire contents of which are incorporated herein by reference.

### TECHNICAL FIELD

The present invention pertains to a vehicle accessory device operating system, with which a plurality of accessory devices housed or to be housed in a vehicle, for example, in a camping vehicle, can be operated.

### TECHNICAL BACKGROUND

It is common to position a camping structure manufactured by a camping vehicle manufacturer onto a basic vehicle manufactured by a vehicle manufacturer, especially during the setup of the camping vehicles. This camping structure comprising, for example, a living area, a plumbing area and a cooking area, is configured as a system set up and to be operated essentially independently of the basic vehicle and may be operated or shall be operated largely independently of the functionality of the basic vehicle.

Different system areas to be operated, accessory devices in the sense of the present invention, are generally provided in such a camping structure. Such an accessory device may be, for example, a parking heater, which can heat the camping structure, for example, the water for the plumbing area as well, and which is operated electrically or operated with fuel independently of the operation of the basic vehicle. An additional accessory device may be, for example, a video system, i.e., for example, a television. An audio system may be provided as an accessory device in the camping structure as well. Additional accessory devices may be provided in the cooking area, for example, in the form of a stove, a microwave, a dishwasher or the like. The lighting system of such a camping structure may also be considered to be an accessory device to be operated by an operator.

Because of the large number of such accessory devices that are provided, for example, in a camping structure of a vehicle, which provide functionalities which are markedly different from one another and are thus also to be operated in a great variety of manners and are provided by different suppliers as well, and because of the circumstance that it is possible to select from among accessory devices of different manufacturers for the configuration of a camping structure in case of different types of accessory devices, it is frequently necessary to keep ready different remote control device for a plurality of such accessory devices in order to also be able to operate these remotely. For example, generally different remote operations coordinated with the functionalities to be provided by these accessory devices are intended for a parking heater, on the one hand, and for a video system, on the other hand.

### SUMMARY

An object of the present invention is to provide a vehicle accessory device operating system, which makes possible a simplified operation of a plurality of accessory devices housed or to be housed in a vehicle.

According to the present invention, this object is accomplished by a vehicle accessory device operating system, comprising:

a plurality of accessory devices housed or to be housed in a vehicle,

a communication unit,

an accessory device data transmission system connecting the plurality of accessory devices for the exchange of data with the communication system, and

at least one mobile operating unit,

wherein the communication unit is configured for the exchange of data with the at least one mobile operating unit by means of a first wireless data transmission system, and wherein the communication unit is configured for the exchange of data with a remote access system by means of a second wireless data transmission system.

A plurality of accessory devices, preferably all accessory devices, which are housed or to be housed in a vehicle, for example, in a camping vehicle, are accessible via a single device, namely via the communication unit, in case of the vehicle accessory device operating system according to the present invention. This communication unit is set up or may be set up to be in connection with a great variety of accessory devices for the exchange of data in case of the configuration of such a vehicle accessory device operating system. In this manner, the communication unit of each of the accessory devices can communicate in order to send operating commands to a particular accessory device, for example, for activating or deactivating this accessory device, but also to read out, for example, the operating state or information representing the functionality of an accessory device from this accessory device and to make same available for corresponding analysis.

Because accessory devices may be housed in spatial areas of a vehicle which are difficult to access in some cases, it is proposed that the accessory device data transmission system comprise a third wireless data transmission system. The laying of data lines especially to accessory devices that are difficult to access can thus be avoided.

Because of the housing in a vehicle, it can be assumed, in principle, that the distance between the communication unit and the accessory devices to be operated via this communication unit is relatively short. For this reason, provisions may be made, for example, for the third wireless data transmission system to comprise a Bluetooth data transmission system.

As an alternative or in addition, provisions may be made for the accessory device data transmission system to comprise a wired data transmission system, for example, if only a relatively short, easy-to-cover distance is present between the communication unit and one or more accessory devices.

The first wireless data transmission system, i.e., the data transmission system, via which the communication system communicates with at least one mobile operating unit, may comprise a Bluetooth data transmission system. It can be assumed here as well that generally an operation of the accessory devices provided in a vehicle takes place when the operator is located in the area of such a vehicle.

In order to make possible access from a greater distance as well, it is provided that the second wireless data transmission system comprise a mobile wireless data transmission system (also known as a cellular network data transmission system). Thus, it becomes possible to communicate with the communication unit via a conventional mobile phone network and with the accessory devices via this communication unit, for example, in order to transmit operating commands to these accessory devices or to send information representing the state of the accessory devices to the remote access system.

This remote access system may be configured, for example, for access over the Internet. It is thus possible to act on the accessory devices over the Internet or via operating programs of the remote access system stored on a server or to store information in these operating programs, which, for example, a workshop, a fleet manager or a mobility service of a vehicle manufacturer may also access in order to be able to access the system as needed or to have available information about the maintenance requirement or need for repairs possibly existing in the area of one or more accessory devices in case of maintenance or repair operations to be performed.

The present invention further pertains to a vehicle, comprising a vehicle device data transmission system for the exchange of data between a plurality of vehicle devices and a plurality of vehicle device actuating units or/and a plurality of vehicle device operating units (vehicle device actuating/operating units), further comprising a vehicle accessory device operating system according to the present invention.

Two data transmission systems, which operate essentially self-sufficiently and can also be operated independently of one another, thus exist, in principle, in such a vehicle. All the system areas of a vehicle, which are provided and are to be operated for the operation of the vehicle, communicate via the vehicle device data transmission system. These system areas, which are vehicle devices in the sense of the present invention, comprise, for example, the drive unit of the vehicle, a heating system or air conditioning system of the vehicle, security systems, for example, also an alarm system, and the like. The accessory devices communicate with the communication unit and are in this manner also accessible by an operator independently of the operation of the vehicle via the vehicle accessory data transmission system, essentially independently of the operation of the vehicle or of the vehicle devices necessary for the operation of the vehicle.

In order to guarantee this operation of vehicle devices independently of one another, on the one hand, and of the accessory devices, on the other hand, it is proposed that no exchange of data take place between the accessory device data transmission system and the vehicle device data transmission system.

The vehicle device data transmission system comprises, for example, a wired data transmission system, preferably a bus data transmission system.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic block view showing a configuration of a vehicle equipped with a plurality of accessory devices.

### DESCRIPTION OF PREFERRED EMBODIMENTS

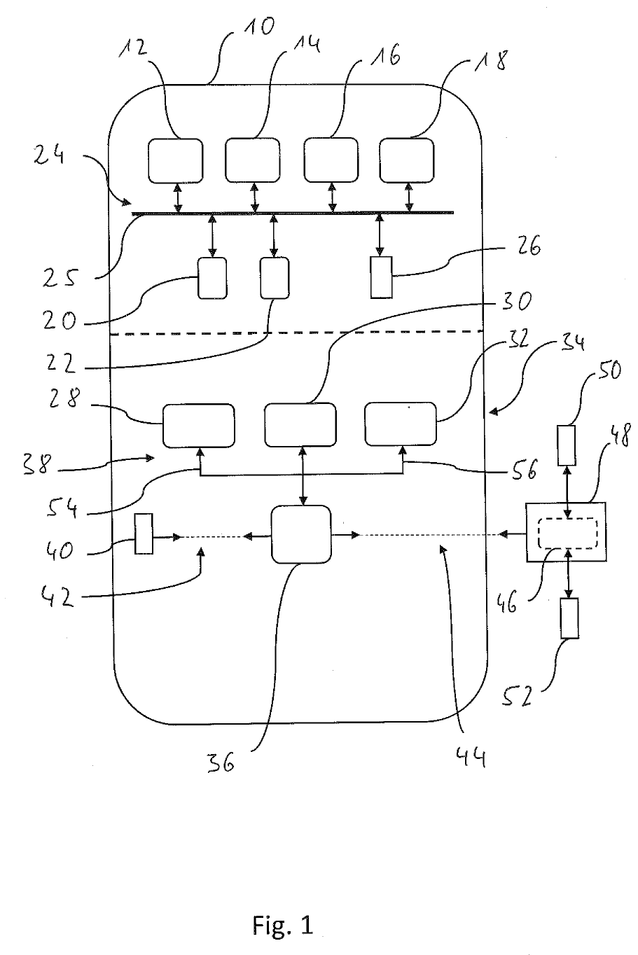

Referring to the drawings, a vehicle is generally designated by 10 in FIG. 1. The vehicle 10 may be, for example, a camping vehicle, in which a camping structure is configured or set up by a camping vehicle manufacturer on a basic vehicle delivered by a vehicle manufacturer. The vehicle 10 or the basic vehicle comprises a plurality of vehicle devices 12, 14, 16, 18 necessary for the operation of same. These vehicle devices 12, 14, 16, 18 may comprise, for example, the drive unit, i.e., for example, an internal combustion engine, the heating system or air conditioning system, an alarm system or other system areas to be actuated in the vehicle, e.g., power windows, a sunroof or the like. A plurality of vehicle device actuating units 20, 22 are generally provided in such a vehicle 10 to operate or put into operation these different vehicle devices 12, 14, 16, 18 in a suitable manner. For example, a defined association of a vehicle device actuating unit with a vehicle device may be present here. It is also possible, in principle, that a plurality of vehicle devices are accessed by such a vehicle device actuating unit or that a vehicle device can receive actuating commands from a plurality of vehicle device actuating devices.

The vehicle device actuating units 20, 22 communicate with the vehicle devices 12, 14, 16, 18 via a vehicle device data transmission system 24, which is provided in such a vehicle 10 and generally comprises a wired data transmission system 25, for example, a bus data transmission system. Further, a communication between one or more vehicle device operating units 26 and the vehicle device actuating units 20, 22 or/and the vehicle devices 12, 14, 16, 18 may also take place via this vehicle device data transmission system 24. Such a vehicle device actuating unit 26 or a plurality of such vehicle device operating units 26 may be housed, for example, in the area of a dashboard, a steering wheel or the doors of a vehicle in order to be able to input operating commands necessary for the operation of one or more vehicle devices 12, 14, 16, 18. For example, such a vehicle device operating unit 26 may be configured in the simplest case as a switch, with which, for example, a light, a windshield wiper or a power window can be activated or deactivated. In case of a more complex configuration, such a vehicle device operating unit 26 may be configured as a touchscreen in order to be able to access different vehicle devices, for example, under menu-guided selection or to be able to input operating commands suitable for different vehicle devices. All system areas that are provided or are necessary for the operation of the vehicle 10 thus communicate via the vehicle device data transmission system 24.

A plurality of accessory devices 28, 30, 32 are provided at the vehicle 10, for example, in case of a configuration as a camping vehicle. These accessory devices 28, 30, 32 may comprise, for example, an electrically operated parking heater or a fuel-operated parking heater, a video system, an audio system, devices housed in a cooking area, a lighting system or the like.

A communication unit 36 is provided in association with these accessory devices 28, 30, 32, which accessory devices 28, 30, 32 are configured, for example, with a camping structure on a basic vehicle or with a vehicle accessory device operating system 34, which accessory device operating system 34 comprises these accessory devices 28, 30, 32. The communication unit 36 is in connection with the accessory devices 28, 30, 32 via an accessory device data transmission system 38 or the communication unit 36 can communicate with the different accessory devices 28, 30, 32 via the accessory device data transmission system 38. The communication unit 36 includes one or more processors with associated memory and a wireless/wired data transmission system transceiver arrangement comprising one or more transceivers such as one or more of a local area network transceiver, a cellular network transceiver, a WiFi transceiver and a Bluetooth transceiver and/or other wired and wireless transceivers. Operating commands that are relevant for the operation of the vehicle accessory devices 28, 30, 32 are transmitted to the vehicle accessory devices 28, 30, 32 via the communication unit 36. For example, a parking heater provided as an accessory device can be switched on and switched off via an operating command transmitted via the communication unit 36. The video system or the audio system of such a vehicle 10 may also be actuated via the communication unit 36 according to the specifications of an operator.

In order to make possible such an interaction of an operator, the vehicle accessory device operating system 34 further comprises at least one mobile operating unit 40. This mobile operating unit 40, which is provided, for example, in the form of a smartphone or tablet computer, may communicate with the communication unit 36 via a first wireless data transmission system 42. For example, the communication unit 36 comprises a Bluetooth transceiver and the first wireless data transmission system 42 comprises a Bluetooth data transmission system, which is especially suitable for wireless data transmission over relatively short distances of a few meters. The actuating commands necessary for the actuation of the different accessory devices 28, 30, 32 may be sent to the communication unit 36 via the mobile operating unit 40. The communication unit 36 may also send information to the mobile operating unit 40, which communication unit 36 has received via the accessory device data transmission system 38 and which represents, for example, the operating state of one or more of the accessory devices 28, 30, 32.

The communication unit 36 comprises a cellular network transceiver communicating with a remote access system 46 via a second wireless data transmission system 44. The second wireless data transmission system 44 is configured, for example, as a mobile wireless data transmission system providing data exchange communications between the communication unit 36 and the remote access system 46 over a mobile phone network (cellular network) that is available almost everywhere.

The remote access system 46 may comprise, for example, operating programs, which are stored on a server and which can thus be accessed over the Internet 48, which is shown only schematically in FIG. 1. By means of one or more access units 50, 52, which are, for example, again configured as a smartphone, tablet computer or PC, the remote access system 46 can thus be accessed over the Internet 48 in order to send actuating commands to the communication unit 36 via the remote access system 46 and the second wireless data transmission system 44, on the one hand, and via this communication unit 36 to individual accessory devices 28, 30, 32, to read out information, which represents the operating state of one or more of the accessory devices 28, 30, 32 and possibly also indicates a possibly existing need for maintenance or repair, via the communication unit 36, on the other hand. Thus, there is an additional communication path with the communication unit 36 via the remote access system 46 not only for an operator, who is possibly also located in the area of the vehicle 10, but it is also possible for a third party, e.g., a fleet manager, a workshop or a mobility service of a vehicle manufacturer to access this information and, if necessary, access the system or obtain information possibly relevant to maintenance or repair operations, which information has become available, during the performance of said operations.

In an especially advantageous configuration, the accessory device data transmission system 38 may be configured as a third wireless data transmission system 54, especially also as a Bluetooth data transmission system. In this manner, a simple data exchange connection can be provided between the communication unit 36 and the accessory devices 28, 30, 32 or at least some of the accessory devices 28, 30, 32 via Bluetooth transceivers. Since such a Bluetooth data transmission system is preferably already provided for communication with the mobile operating unit 40, communication between the communication unit 36 and the accessory devices which are accessible in this manner may ultimately take place through the same system.

In case of an alternative configuration, the accessory device data transmission system 38 may be configured as a wired data transmission system 56. This is especially possible if the accessory devices to be accessed in this manner are easily accessible and thus the wires or cables necessary for the transmission of data or information can be easily laid between the communication unit 36 and the accessory devices in question. Of course, it is also possible to couple some of the accessory devices with the communication unit 36 via the third wireless data transmission system 54 and to couple some of the accessory devices with the communication unit 36 via the wired data transmission system 56. Such a wired data transmission system 56 may also be configured, for example, as a bus data transmission system.

In case of the configuration of such a vehicle accessory device operating system 34, after the vehicle accessory device operating system 34 has been established, which accessory devices shall be integrated into the system by which manufacturer, the communication unit 36 may be equipped with one or more operating programs that make communication with these specially selected accessory devices possible in order to be able to transmit operating commands and information necessary for these accessory devices 28, 30, 32. Such operating programs, which act like device drivers, may be stored, for example, in the communication unit 36 and only the operating programs, which are necessary for the accessory devices intended for the system, can be activated or loaded in case of the configuration of the vehicle accessory device operating system. Actuating programs, which are intended for the accessory devices 28, 30, 32 provided in the vehicle accessory device operating system 34, may also be stored, for example, in the form of one or more apps in the mobile operating unit 40. If, for example, a parking heater provided as an accessory device shall be accessed, it is possible to send an operating command in the direction of the communication unit 36 and to the corresponding accessory device, i.e., to the parking heater via this communication unit 36, on the one hand, or/and to read out information from this accessory device by activating a corresponding app or the area of an app associated with the parking heater.

It is clear from the above description that the vehicle accessory device operating system 34 is provided as a system operating essentially independently and self-sufficiently of the rest of the vehicle 10, especially the vehicle devices 12, 14, 16, 18 and the vehicle device data transmission system 24. An exchange of data between these areas of the vehicle 10 is, in principle, not necessary, so that the vehicle device data transmission system 24 and the accessory device data transmission system 38 are, in principle, also not coupled or do not have to be coupled with one another for the exchange of data. This is especially advantageous because also no access possibility has to be created in case of setting up a camping structure on a basic vehicle in order to be able to establish such a connection between the accessory device data transmission system 38 and the vehicle device data transmission system 24. On the other hand, this mutually uncoupled configuration allows the operation of the vehicle accessory device operating system even if the vehicle device data transmission system and the system areas coupled therewith are inactive. The electricity for the operation of the accessory devices may be supplied here, for example, from the vehicle battery, or, as an alternative or in addition, from an auxiliary battery exclusively provided the operation thereof.

While specific embodiments of the invention have been shown and described in detail to illustrate the application of the principles of the invention, it will be understood that the invention may be embodied otherwise without departing from such principles.

What is claimed is:

1. A vehicle accessory device operating system comprising:
a plurality of accessory devices housed in a vehicle or to be housed in a vehicle;
a communication unit;
an accessory device data transmission system connecting the plurality of accessory devices to the communication unit for an exchange of data between the plurality of accessory devices and the communication unit; and
at least one mobile operating unit, wherein the communication unit is configured to exchange data with the at least one mobile operating unit via a first wireless data transmission system, and the communication unit is configured to exchange data with a remote access system via a second wireless data transmission system.

2. A vehicle accessory device operating system in accordance with claim 1, wherein the accessory device data transmission system comprises a third wireless data transmission system.

3. A vehicle accessory device operating system in accordance with claim 2, wherein the third wireless data transmission system comprises a Bluetooth data transmission system.

4. A vehicle accessory device operating system in accordance with claim 1, wherein the accessory device data transmission system comprises a wired data transmission system.

5. A vehicle accessory device operating system in accordance with claim 1, wherein the first wireless data transmission system comprises a Bluetooth data transmission system.

6. A vehicle accessory device operating system in accordance with claim 1, wherein the second wireless data transmission system comprises a mobile wireless data transmission system.

7. A vehicle accessory device operating system in accordance with claim 1, wherein the remote access system is configured for access over the Internet.

8. A vehicle comprising:
a plurality of vehicle accessory devices;
a plurality of vehicle device actuating units or/and a plurality of vehicle device operating units;
a vehicle device data transmission system for the exchange of data between the plurality of vehicle devices and the plurality of vehicle device actuating units or/and the plurality of vehicle device operating units; and
a vehicle accessory device operating system comprising: a plurality of accessory devices housed in the vehicle or connectable with the vehicle; a communication unit; an accessory device data transmission system connecting the plurality of accessory devices to the communication unit for an exchange of data between the plurality of accessory devices and the communication unit; and at least one mobile operating unit, wherein the communication unit is configured to exchange data with the at least one mobile operating unit via a first wireless data transmission system, and the communication unit is configured to exchange data with a remote access system via a second wireless data transmission system.

9. A vehicle in accordance with claim 8, wherein no exchange of data takes place between the accessory device data transmission system and the vehicle device data transmission system.

10. A vehicle in accordance with claim 8, wherein the vehicle device data transmission system comprises a wired data transmission system including a data bus.

11. A vehicle accessory device operating system comprising:
a plurality of vehicle accessory devices;
an accessory device data transmission system;
a mobile operating unit; and
a communication unit comprising a data transmission system transceiver arrangement, wherein the accessory device data transmission system connects the plurality of accessory devices to the communication unit via the data transmission system transceiver arrangement for an exchange of data between the plurality of accessory devices and the communication unit, a first wireless data transmission system connects the at least one mobile operating unit to the communication unit via the data transmission system transceiver arrangement for an exchange of data between the at least one mobile operating unit and the communication unit and a second wireless data transmission system connects a remote access system to the communication unit via the data transmission system transceiver arrangement for an exchange of data between the remote access system and the communication unit.

12. A vehicle accessory device operating system in accordance with claim 11, wherein:
the wireless data transmission system transceiver arrangement comprises a Bluetooth transceiver for data exchange with the at least one mobile operating unit via a Bluetooth wireless data transmission system as the first wireless data transmission system; and
the wireless data transmission system transceiver arrangement comprises a cellular network transceiver for data exchange with the remote access system via a cellular network as the second wireless data transmission system.

13. A vehicle accessory device operating system in accordance with claim 12, wherein the accessory device data transmission system comprises a third wireless data transmission system.

14. A vehicle accessory device operating system in accordance with claim 13, wherein the third wireless data transmission system comprises a Bluetooth data transmission system.

15. A vehicle accessory device operating system in accordance with claim 11, wherein the accessory device data transmission system comprises a wired data transmission system.

16. A vehicle accessory device operating system in accordance with claim 11, wherein the first wireless data transmission system comprises a Bluetooth data transmission system.

17. A vehicle accessory device operating system in accordance with claim 11, wherein the second wireless data transmission system comprises a mobile wireless data transmission system.

18. A vehicle accessory device operating system in accordance with claim 11, wherein the remote access system is configured for access over the Internet.
